(19) United States
(12) Patent Application Publication
(10) Pub. No.: US 2006/0262773 A1
(43) Pub. Date: Nov. 23, 2006

(54) Router device and communication system

(75) Inventor: Yoshifumi Tanimoto, Hirakata-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/404,753

(22) Filed: Apr. 17, 2006

(30) Foreign Application Priority Data
May 19, 2005 (JP) 2005-146584

(51) Int. Cl. H04L 12/28

(52) U.S. Cl. 370/351; 370/401

(57) ABSTRACT

A router device stores a table in which a port number of a WAN is associated with a private address of a plurality of terminal devices in a LAN. When receiving a TCP connection request from a remote terminal device in the WAN, the router device selects a communication terminal device in the LAN according to the table and establishes a connection. A terminal device having a small communication load may be selected.

### BACKGROUND OF THE INVENTION

1. Field of the Invention

The present invention relates to a router device and a communication system using the router device. In particular, the present invention relates to a connection established between a remote terminal device and a communication terminal device in a Local Area Network (LAN).

2. Description of the Related Art

For carrying out communication between a communication terminal device in a LAN and a remote communication terminal device, a router device converts a remote port number of a received packet into a private address. The router device notifies a transfer port number to the remote communication terminal device one-by-one. However, each time when a number of communication terminal devices in the LAN increases or decreases, a port number of a transfer destination must be assigned.

### SUMMARY OF THE INVENTION

An advantage of the present invention is to provide a router device and a communication system which simplify a port transfer setting and are capable of flexibly supporting an increase or a decrease in a number of communication terminal devices. Another advantage of the present invention is to continuously carry out a transfer to a selected terminal device in a LAN until the end of a communication. Another advantage of the present invention is to detect a communication load of a Transmission Control Protocol (TCP) connection of a terminal device in a LAN and to transfer a packet from a remote terminal device to a terminal device having a small communication load to prevent the communication load from being placed unevenly on a specific terminal device.

According to a preferred aspect of the present invention, a router device includes a Wide Area Network (WAN) interface and a LAN interface. The router device stores a table in which a private address of a plurality of communication terminal devices connected in a LAN is associated with one port number of a WAN. At a TCP connection request from a remote terminal device in the WAN, one communication terminal device is selected from the table according to the port number. A private address of the selected communication terminal device and an Internet Protocol (IP) address of the remote terminal device are associated and stored until the end of the communication. A packet received from the WAN is transferred to the communication terminal device having the private address associated with the IP address of the remote terminal device.

Preferably, a communication load of a TCP connection of the communication terminal devices in the LAN is detected, and a communication terminal device having a small communication load is selected.

Preferably, the communication load is a number of connections of the TCP connection.

Preferably, the communication load is a delay time of a response packet from the communication terminal devices in the LAN.

Preferably, the communication load is a number of times of retransmission of the packet to the communication terminal devices in the LAN. Further, instead of directly detecting the number of times of the retransmission of the packet, the number of times of the retransmission may be detected indirectly by detecting a number of retransmission requests.

According to another preferred aspect of the present invention, a communication system includes a router device connected to the Internet and a plurality of communication terminal devices in a LAN connected to the router device. The router device stores a table in which a private address of the plurality of the communication terminal devices connected in the LAN is associated with one port number of the Internet side. When receiving a TCP connection request from a remote terminal device, the router device selects one of the communication terminal devices from the table according to the port number. The router device associates and stores the private address of the communication terminal device and an IP address of the remote terminal device until the end of the communication. The router device transfers a packet received from the Internet to the communication terminal device having the private address associated with the IP address of the remote terminal device.

Preferably, the router device detects a communication load of a TCP connection of the communication terminal devices in the LAN, and selects a communication terminal device having a small communication load when receiving the TCP connection request from the remote terminal device.

Preferably, the communication load is detected from a number of connections of the TCP connection.

Preferably, the communication load is detected from a delay time of a response packet from the communication terminal devices in the LAN.

Preferably, the communication load is detected from a number of times of retransmission of the packet to the communication terminal devices in the LAN. Further, instead of directly detecting the number of times of the retransmission of the packet, the number of times of the retransmission may be detected indirectly by detecting a number of retransmission requests.

According to the preferred aspect of the present invention, in the router device, one port number at a WAN is associated with the private address of the plurality of the communication terminal devices in the LAN. Therefore, a port number is not required to be assigned to each of the communication terminal devices. When a communication terminal device is added or removed, a port number is not required to be newly added or deleted. The addition or the removal of the communication terminal device can be supported just by registering or deleting a private address with respect to the port number. The packet is transferred continuously to the communication terminal device, which has established the communication, until the end of the communication. Therefore, the packet addressed to such a communication terminal device is not transferred to another communication terminal device.

A communication terminal device having a small communication load is selected and assigned as the communication terminal device of the transfer destination. Therefore, the communication load does not concentrate on a specific communication terminal device in the LAN.

Since the communication load is detected from the number of the connections of the TCP connection of the communication terminal devices in the LAN, the communication load can be detected easily.

Since the communication load is detected from the delay time of the response packet from the communication terminal devices in the LAN, the communication load can be detected easily.

Since the communication load is detected from the number of times of the retransmission of the packet to the communication terminal devices in the LAN, the communication load can be detected easily.

Other features, elements, processes, steps, characteristics and advantages of the present invention will become more apparent from the following detailed description of the preferred embodiments of the present invention with reference to the attached drawings.

### BRIEF DESCRIPTION OF THE DRAWINGS

FIG. 1 illustrates a configuration of a router device and a connection between the router device and terminal devices inside and outside of a LAN according to a preferred embodiment of the present invention.

FIG. 2 illustrates a terminal device address registration table stored in the router device according to a preferred embodiment of the present invention.

FIG. 3 is a flowchart illustrating an outline of a process carried out by the router device according to a preferred embodiment of the present invention.

FIG. 4 illustrates a communication load management table stored in the router device according to a preferred embodiment of the present invention.

FIG. 5 schematically illustrates a connection request from terminal devices outside of the LAN according to a preferred embodiment of the present invention.

FIG. 6 is a flowchart illustrating an algorithm of a process carried out by the router device at a TCP connection request according to a preferred embodiment of the present invention.

### DETAILED DESCRIPTION OF PREFERRED EMBODIMENTS

A description will be made of the preferred embodiments of the present invention.

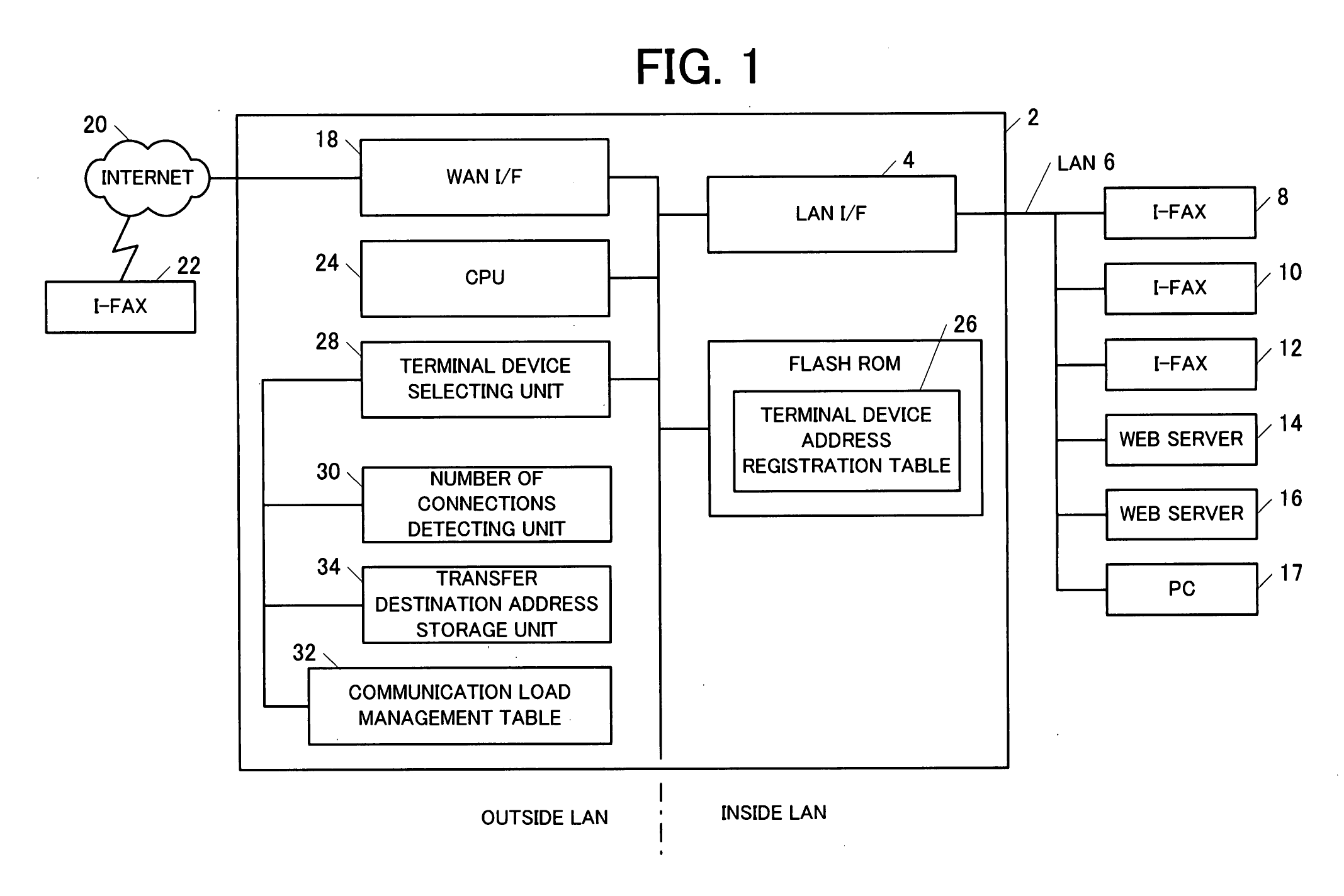

FIG. 1 through FIG. 6 illustrate preferred embodiments of the present invention. FIG. 1 illustrates a configuration of a router device (hereinafter “router”) 2 and a relation between the router 2 and communication terminal devices or the like in a LAN. A description will be made of a case where a communication request is made by designating a port number of the router 2 from a remote terminal device outside the LAN. The router 2 is connected to a plurality of Internet facsimile machines (in the drawings “I-FAX”) 8 through 12, web servers 14 and 16 and a Personal Computer (PC) 17 or the like via a LAN interface (in the drawings, “LAN I/F”) 4 and a LAN 6. A communication terminal device, such as the Internet facsimile machines 8 through 12, is connected to a remote terminal device via a WAN interface (in the drawings, “WAN I/F”) 18 and the Internet 20. For example, the router 2 transfers a packet from an Internet facsimile machine 22 to the communication terminal device in the LAN, for example, the Internet facsimile machine 8, by using the TCP.

In the drawing, reference numeral 24 denotes a main control unit (Central Processing Unit (CPU)), and 26 denotes a terminal device address registration table stored in a flash Read Only Memory (ROM). The terminal device address registration table 26 manages a port number assigned to the router 2 and a private address of a plurality of communication terminal devices in the LAN associated with the port number. Further, association of the port number and the private address of the communication terminal devices in the LAN can be registered from the PC 17 or the like.

Reference numeral 28 denotes a terminal device selecting unit. When receiving a communication request from the remote Internet facsimile machine 22, the terminal device selecting unit 28 selects a communication terminal device registered in the terminal device address registration table 26 according to the port number and decides the communication terminal device of a transfer destination. For a selection of the communication terminal device, a communication terminal device having a small communication load is selected from the communication terminal devices in the LAN, and communication is established. Reference numeral 30 denotes a number of connections detecting unit. The number of connections detecting unit 30 detects a number of connections for each of the communication terminal devices 8 through 12 or 14 and 16 from a communication load management table 32, and a device having a small number of connections is selected. In the present preferred embodiment, a magnitude of the communication load of each communication terminal device is determined according to the number of connections. Further, in the present preferred embodiment, the communication terminal device is an Internet facsimile machine, a web server or a PC. A type of the communication terminal device of the transfer destination is decided according to the port number designated from the remote terminal device. The communication terminal device in the LAN may be a mail server. The remote terminal device may be a communication device such as a mobile telephone.

Reference numeral 34 denotes a transfer destination address storage unit. When a connection is established with the communication terminal device selected by the terminal device selecting unit 28, the transfer destination address storage unit 34 associates the private address of the selected communication terminal device and the IP address of the remote terminal device and stores into the communication load management table 32. The private address of the communication terminal device associated with the IP address written in the packet received from the remote terminal device is obtained from the communication load management table 32. Then, by transferring the packet, the connection is maintained until the end of the communication. The communication load management table 32 is also a correspondence chart of an address of the remote terminal device and the communication terminal devices in the LAN. The communication load management table 32 stores a number of connections, and indicates the communication load.

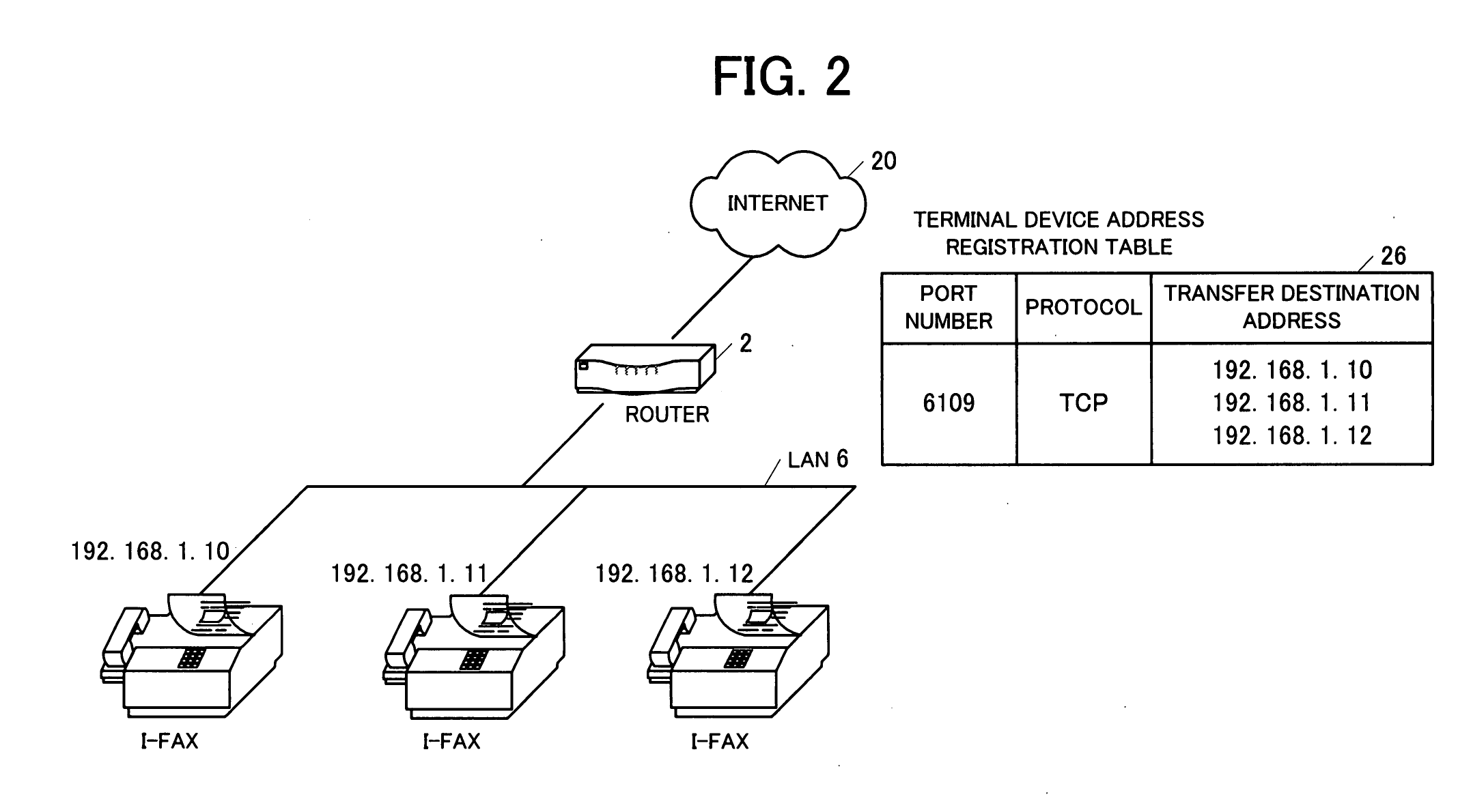

FIG. 2 illustrates the terminal device address registration table 26 stored in the router 2. In FIG. 2, the communication protocol is the TCP. A private address of three Internet facsimile machines is assigned to one port number “6109”. That is, private addresses “192.168.1.10” through “192.168.1.12” are respectively assigned to each communication terminal device connected to the router 2. Each of the communication terminal devices having the port number “6109” carries out communication with the remote terminal device. In the present preferred embodiment, when a communication terminal device is added or removed in the LAN, the private address of the communication terminal device associated with the same port number is newly added or deleted in the terminal device address registration table 26. When the private address of a plurality of communication terminal devices is associated with the same port number and a port number written in a TCP header of the packet received from the remote terminal device is “6109”, the router 2 transfers the received packet to the communication terminal device selected from the private address registered in the terminal device address registration table 26 to establish communication between the remote terminal device and the selected communication device in the LAN.

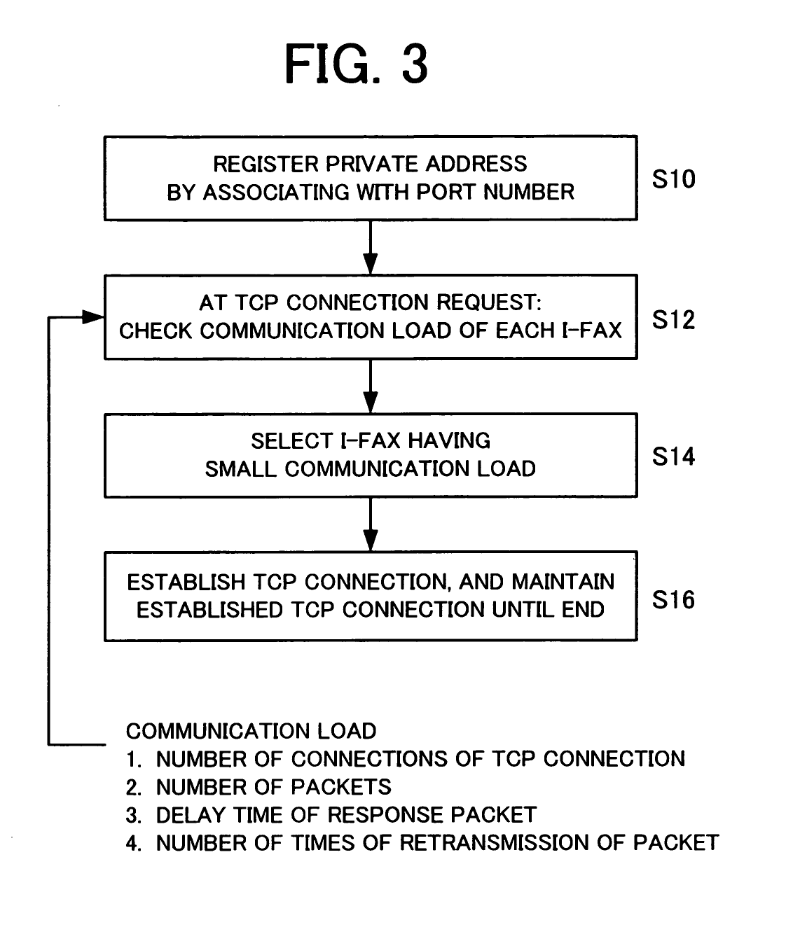

FIG. 3 illustrates an outline of the process executed by the router 2 according to the present preferred embodiment of the present invention. The router 2 associates the private address of the communication terminal device in the LAN with the port number and stores in the terminal device address registration table 26 (step S10). Further, the registration to the terminal device address registration table 26 is executed previously from the PC 17 or the like connected to the router 2. When receiving a TCP connection request from the remote terminal device, the router 2 checks the communication load of the communication terminal device in the LAN having the private address registered in the terminal device address registration table 26 by using the communication load management table 32 (step S12). In the present preferred embodiment, the communication load is detected by detecting a number of connections of the TCP connection of each communication terminal device from the communication load management table 32. That is, the communication load of each communication terminal device can be learnt from the number of connections of the communication terminal device under a connected state at this point of time. The communication load may be obtained from a number of packets by the TCP, a delay time of a response packet from the communication terminal device in the LAN, or a number of times of retransmission of the packet to the communication terminal device in the LAN. Instead of directly detecting the number of times of the retransmission of the packet, the number of times of the retransmission may be detected indirectly by detecting a number of retransmission requests, and the communication load may be obtained.

Then, a communication terminal device on a standby or a communication terminal device having a small communication load is selected (step S14) such that the communication load is evenly dispersed in the LAN to prevent an excess communication load from being imposed on a specific communication terminal device. An address of a transmitter and a transfer destination device is associated and stored in the communication load management table 32. Accordingly, when a TCP connection is established with the selected communication terminal device, the established TCP connection is maintained until the communication ends (step S16).

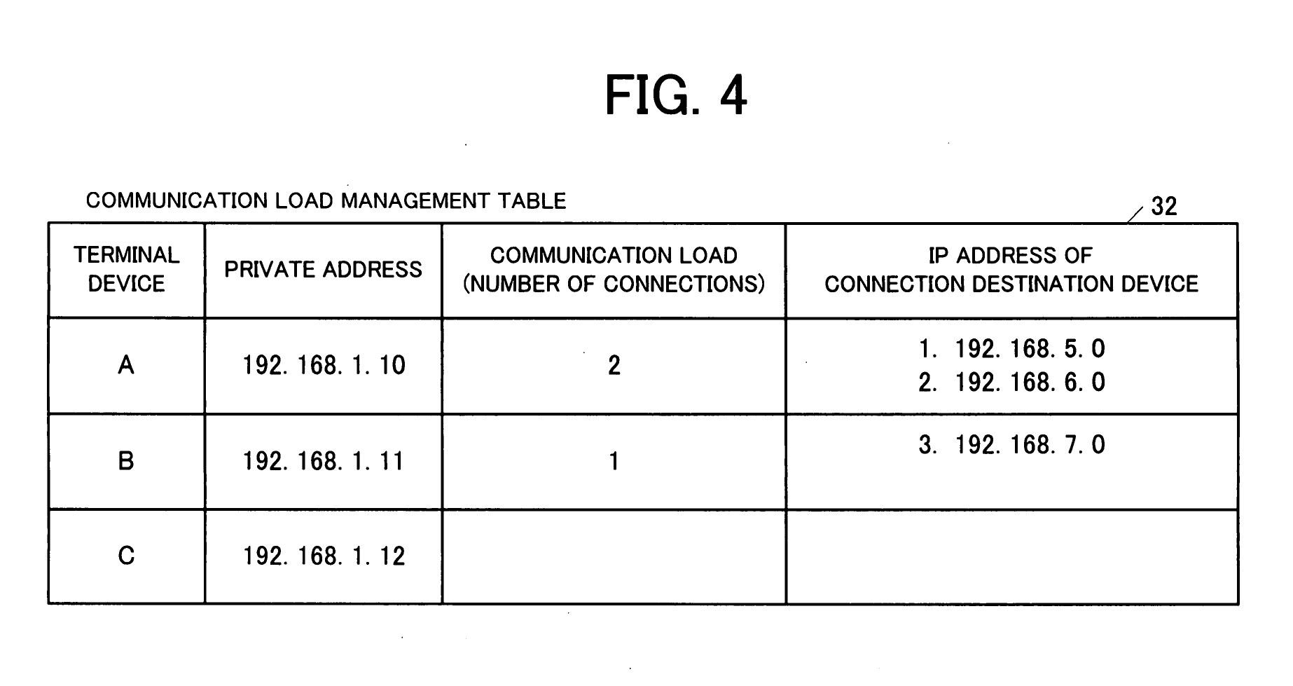

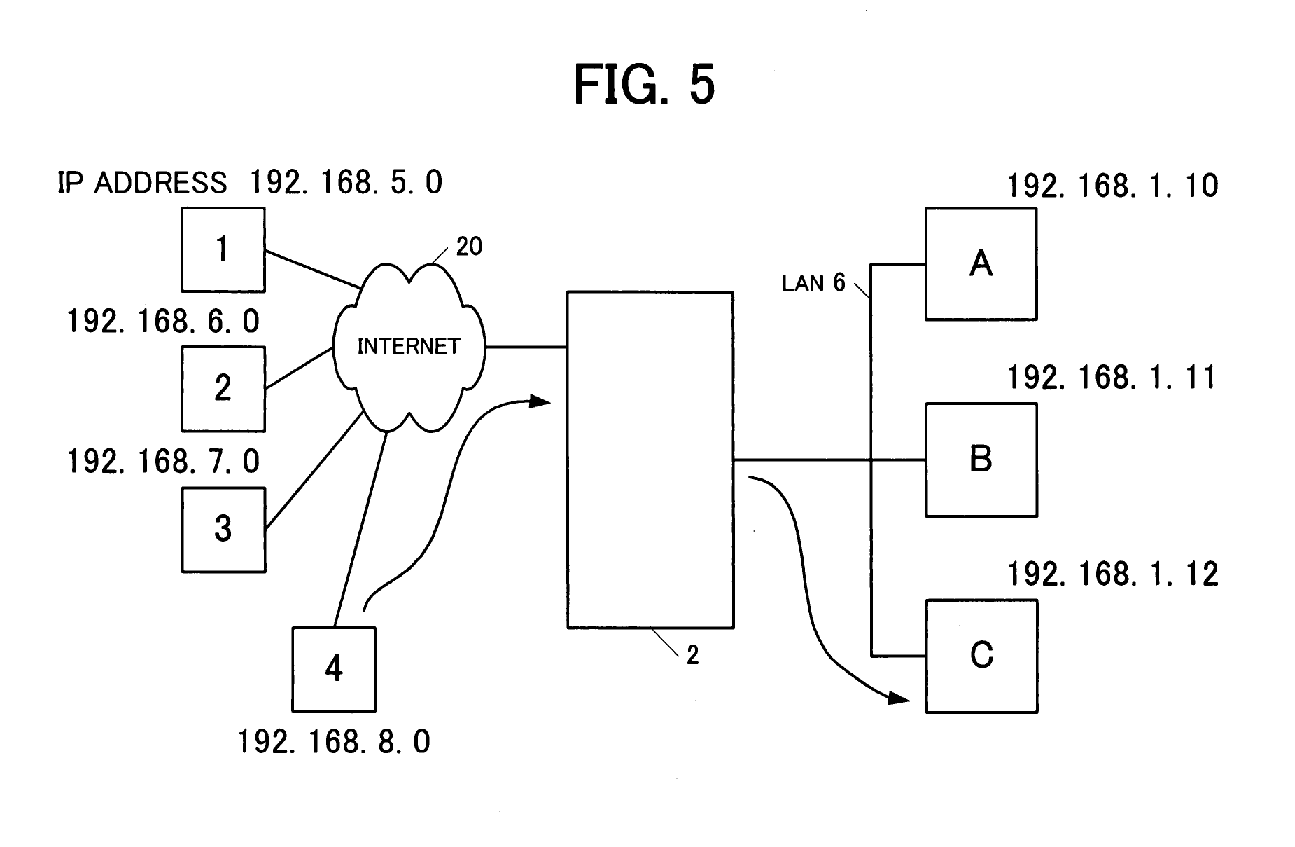

FIG. 4 illustrates an example of the communication load management table 32. FIG. 5 illustrates a connection state of the communication terminal devices or the like corresponding to the communication load management table 32. In the drawings, communication terminal devices A through C are communication terminal devices in the LAN, and remote terminal devices 1 through 4 are connected via the Internet 20. The remote terminal devices 1 through 4 request a connection to the router 2. The communication load management table 32 stores information that the communication terminal device A is connected to the remote terminal devices 1 and 2 and that a number of connections is two. In addition, in the communication load management table 32, an IP address of each of the remote terminal devices 1 and 2 is respectively associated with a private address of the communication terminal device A and stored. The communication terminal device B is connected to the remote terminal device 3, and a number of connections is one. A private address of the communication terminal device B is associated with an IP address of the remote terminal device 3. A private address of a transfer destination device can be obtained from an IP address of a remote terminal device written in a packet, and the connection can be continued.

In the communication load management table 32, the communication terminal device C is on standby. For example, when the router 2 receives a connection request from the remote terminal device 4, the router 2 refers to the communication load management table 32 and preferentially allocates the communication terminal device C on standby. When the communication terminal device C is also during communication, for example, a device having a small communication load is selected from the communication load management table 32 and preferentially allocated.

In the present preferred embodiment, the communication load is obtained according to the number of connections. Alternatively, the communication load may be obtained from a number of packets transferred from the router 2, and a communication terminal device with a large number of packets may be determined to have a large communication load. As another example, the communication load may be determined to be large according to a delay time of a response packet from a communication terminal device in the LAN, or according to a number of retransmission requests of the packet, or according to a number of times of the retransmission of the packet.

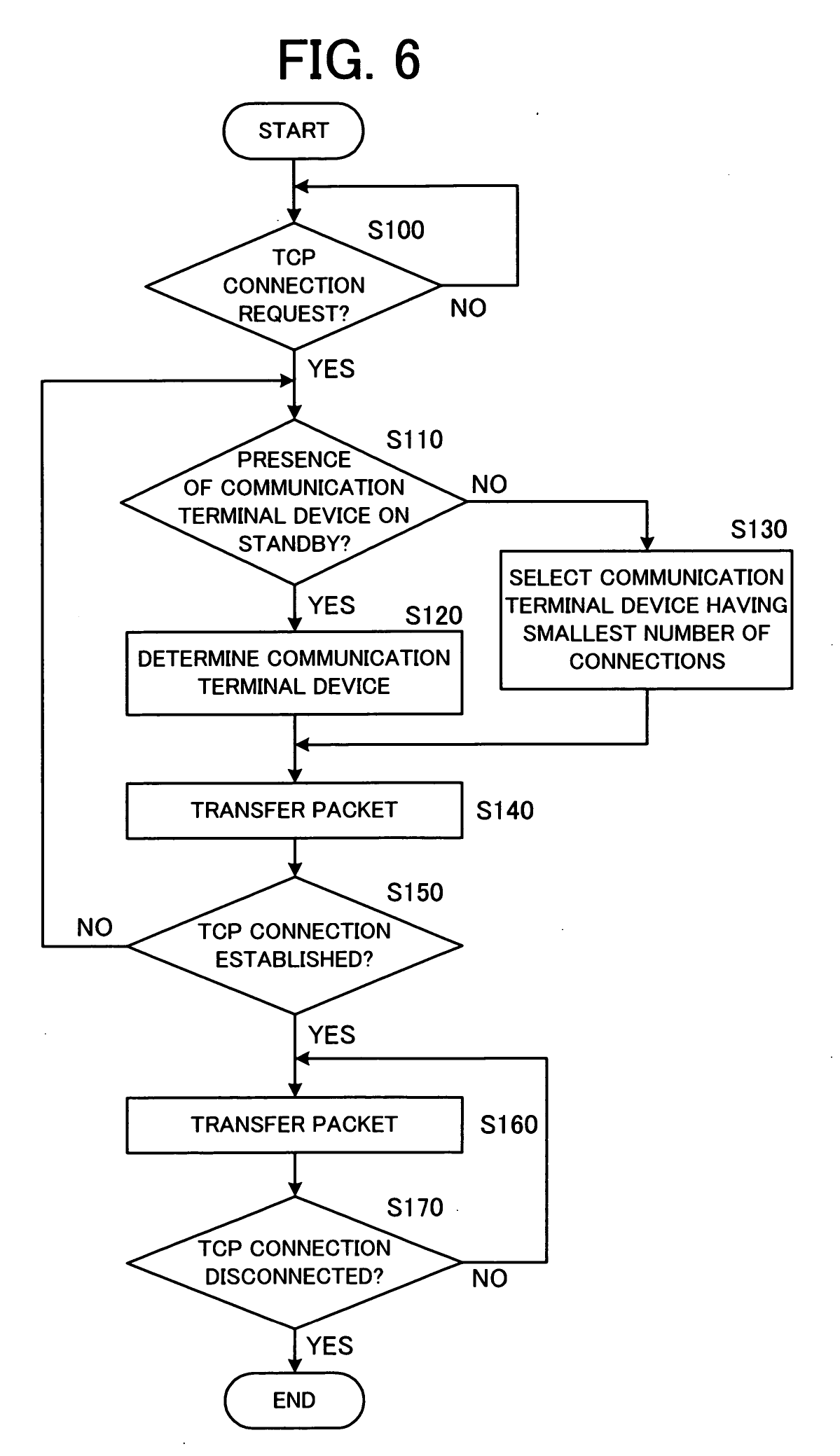

FIG. 6 is a flowchart illustrating a process executed by the router 2 for selecting a communication terminal device in the LAN and establishing a connection. When the router 2 receives a TCP connection request (step S100), the router 2 checks a presence or an absence of a communication terminal device on standby by using the communication load management table 32 (step S110). In case of the presence of the communication terminal device on standby, the router 2 preferentially selects such a communication terminal device (step S120) and establishes a connection with the selected communication terminal device. In case of the absence of the communication terminal device on standby, the router 2 selects a communication terminal device having a smallest number of connections (step S130) to disperse the communication load in the LAN. Then, the router 2 transfers a packet for starting a connection with the selected communication terminal device (step S140). When a TCP connection is established (step S150), the router 2 transfers a packet (step S160). To continuously transfer packets to the same communication terminal device, an address of a connected communication terminal device is respectively registered in the communication load management table 32. Until the communication ends and the TCP connection is disconnected, the router 2 transfers packets and maintains the communication during this period of time (step S170). When the TCP connection fails to be established, the router 2 refers to the communication load management table 32 again and selects a connectable communication terminal device (steps S150, S110).

As described above, according to the present preferred embodiment, the router stores a table in which a plurality of communication terminal devices are registered as a transfer destination with respect to one port number. When receiving a TCP connection request addressed to the port number, one communication terminal device is selected from the registered communication terminal devices, and the connection request is transferred. After the TCP connection has been established, until the established TCP connection ends, data received in the TCP connection is transferred to the selected communication terminal device. Therefore, a new port number is not required to be newly assigned or deleted each time when a communication terminal device is added or removed. The addition or the removal of the communication terminal device can be supported just by registering or deleting a private address of the communication terminal device.

When selecting a communication terminal device of a transfer destination, a device having a small communication load is selected from the communication terminal devices in the LAN. As a result, the communication load is prevented from concentrating on a specific communication terminal device. For example, a number of TCP connections is used for the communication load. In addition to the detection of the communication load, the private address of the communication terminal device in the LAN and the IP address of the remote terminal device being connected are associated. Therefore, the connection is maintained until the communication ends, and the packet is not transferred to another device.

Further, instead of directly associating a port number and a private address, a name of a communication terminal device in the LAN may be associated with the port number, and the name of the communication terminal device in the LAN may be associated with the private address in another table.

While the present invention has been described with respect to the preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the present invention.

What is claimed is:

1. A router device, comprising:
a Wide Area Network (WAN) interface unit;
a Local Area Network (LAN) interface unit:
a table which associates a private address of a plurality of communication terminal devices connected to a LAN with one port number of a WAN;
a selecting unit which refers to the table according to the port number and selects one associated communication terminal device in the LAN when receiving a Transmission Control Protocol (TCP) connection request from a remote terminal device in the WAN;
a storage unit which associates and stores the private address of the selected communication terminal device and an Internet Protocol (IP) address of the remote terminal device until the end of the TCP connection; and
a transfer unit which transfers a packet received from the remote terminal device to the communication terminal device having the private address associated with the IP address of the remote terminal device.

2. The router device according to claim 1, wherein the selecting unit detects a communication load of the Transfer Control Protocol (TCP) connection of the communication terminal devices in the Local Area Network (LAN) and selects a communication terminal device in the LAN in accordance with the table and the detected communication load.

3. The router device according to claim 2, wherein the communication load is a number of connections of the Transmission Control Protocol (TCP) connection.

4. The router device according to claim 2, wherein the communication load is a delay time of a response packet from the communication terminal device in the Local Area Network (LAN).

5. The router device according to claim 2, wherein the communication load is a number of times of retransmission of the packet to the communication terminal device in the Local Area Network (LAN).

6. A communication system, comprising:
a router device connected to the Internet; and
a plurality of communication terminal devices in a Local Area Network (LAN) connected to the router device, wherein the router device:
a storage unit to store a table in which a private address of a plurality of communication terminal devices connected in the LAN is associated with one port number of the Internet;
a selecting unit one of the communication terminal devices by referring to the table according to the port number at a Transmission Control Protocol (TCP) connection request from a remote terminal device connected to the Internet;
a transferring unit to store the private address of the selected communication terminal device and an Internet Protocol (IP) address of the remote terminal device until an end of the TCP connection; and to transfer a packet received from the remote terminal device to the communication terminal device having the private address associated with the IP address of the remote terminal device.

7. The communication system according to claim 6, wherein the router device detects a communication load of the Transmission Control Protocol (TCP) connection of the communication terminal devices in the Local Area Network (LAN) and selects the communication terminal device in accordance with the table and the communication load at a TCP connection request from the remote terminal device.

8. The communication system according to claim 7, wherein the communication load is a number of connections of the Transmission Control Protocol (TCP) connection.

9. The communication system according to claim 7, wherein the communication load is a delay time of a response packet from the communication terminal device in the Local Area Network (LAN).

10. The communication system according to claim 7, wherein the communication load is a number of times of retransmission of the packet to the communication terminal device in the Local Area Network (LAN).
